(19) United States
(12) Patent Application Publication
(10) Pub. No.: US 2003/0160760 A1
(43) Pub. Date: Aug. 28, 2003

(54) Image comining apparatus and method

(75) Inventors: Hiroyuki Takakura, Kawasaki (JP); Kenichiro Sakai, Kawasaki (JP); Nobuyasu Yamaguchi, Kawasaki (JP); Tsugio Noda, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/364,453

(22) Filed: Feb. 12, 2003

(30) Foreign Application Priority Data
Feb. 28, 2002 (JP) 2002-054788

(51) Int. Cl. G09G 5/08

(52) U.S. Cl. 345/158

(57) ABSTRACT

First, a tilt angle relative to paper or a subject of each input image is obtained. Then, the tile of each input image is corrected based on the detected tilt angle. Using the corrected input image or an image obtained by reducing the amount of data of the corrected input image, the overlapping position between the two input images is detected. Finally, two input images are combined in the detected overlapping position.

### BACKGROUND OF THE INVENTION

1. Field of the Invention

The present invention relates to a method for generating an image by combining a plurality of images when a photo or a piece of paper exceeding a read width of a scanner, or a subject exceeding a shooting range of a camera is input in a plurality of inputting operations using a scanner, a digital camera, etc.

2. Description of the Related Art

Recently, for instance, a stationary flat bed scanner, an easily portable hand-operated small hand-held scanner has been developed and brought to a commercial stage. Since the hand-held scanner has a small body, its scanning width is small. Additionally, most flat bed scanners come in the A4 size, and cannot fetch an entire image on a large piece of paper such as newspaper, etc. To fetch a large image exceeding a scanner width, it is necessary to first section the image, then fetch the image sections in a plurality of fetching operations (FIG. 1), and finally combine them (FIG. 2).

A number of images fetched using a scanner and a digital camera are input as tilted relative to the paper and subject (FIG. 3). When images are combined, the detection accuracy of the overlapping position is lowered unless the tilt of each image is corrected (FIG. 4). However, since the overlapping positions of the images do not completely match although the overlapping position can be detected, the image quality of the combined portion is lowered due to the influence of the pixel shift. Furthermore, since the combined image indicates a change in tilt on both sides of the combined portion, it appears a distorted image.

However, the image combining capability of normally marketed photo-retouching software does not have the technology of automatically correcting a tilt. Since it is necessary for a user to manually correct a tilt, the user feels inconvenience. Additionally, a tilt cannot be accurately corrected (partly depending on the technique of a user).

As described above, according to the conventional image combining technology, a user has to manually correct the tilts of images before combining a plurality of images. Therefore, there has been the problem that the conventional technology has been inconvenient and has difficulty in accurately correcting the tilts of images.

Furthermore, when the image fetched using the above mentioned scanner and digital camera has multivalued color elements such as a full-color image, etc., there have been various problems that the process load is heavy (process speed is low), a large memory capacity is required during the processes, etc.

### SUMMARY OF THE INVENTION

The present invention aims at providing an apparatus and a method in the technology of combining images by reading an entire image in a plurality of reading operations after automatically correcting the tilt of each input image, thereby improving the convenience to a user, accurately combining a plurality of input images, and performing a high speed process although there is a large amount of data of input images.

The image combining apparatus according to the present invention includes: a tilt angle detection unit for obtaining a tilt angle of each input image for a plurality of input images obtained in two or more fetching operations; a tilt angle correction unit for correcting the tilt angle of each input image based on the tilt angle detected by the tilt angle detection unit; an overlapping position detection unit for detecting the overlapping position between input images using the input images whose tilt angles are corrected by the tilt angle correction unit; and an image combining unit for combining the plurality of input images based on the overlapping position detected by the overlapping position detection unit.

Since the above mentioned image combining apparatus detects an overlapping position after automatically correcting the tilt of each input image before combining images, the overlapping position can be accurately detected. Thus, a combined image obtained by combining images can be excellent in image quality without lowering the image quality on the combined portion or indicating a distorted image on the whole. Furthermore, since it is not necessary for a user to manually correcting the tilt of an image, the user can feel improved convenience.

### BRIEF DESCRIPTION OF THE DRAWINGS

FIG. 1 shows the process of reading image sections obtained in two or more fetching operations;

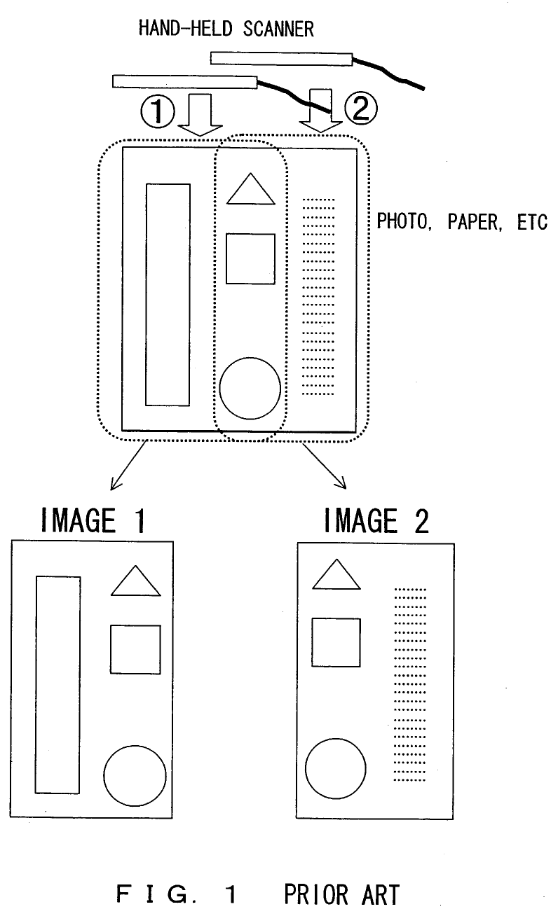

FIG. 2 shows the process of combining the plurality of read images obtained in two or more fetching operations in FIG. 1;

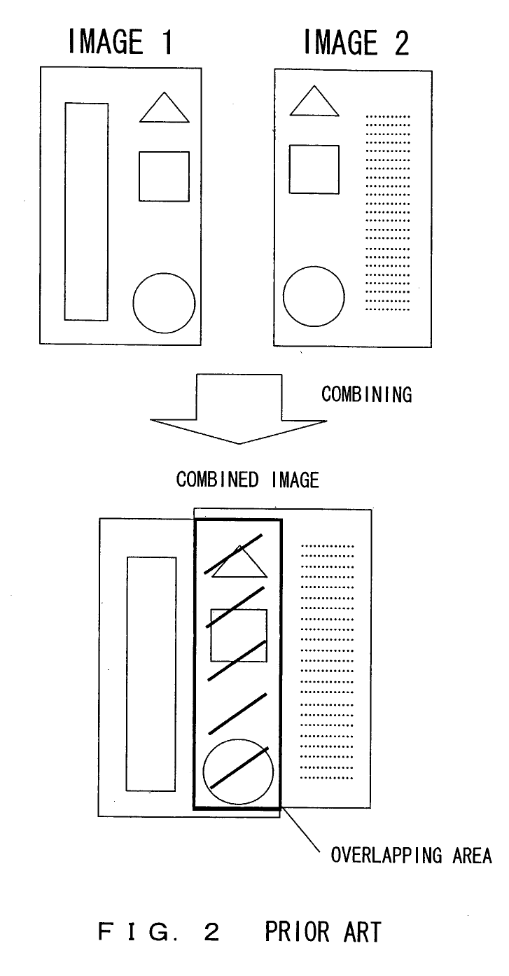

FIG. 3 shows the process of reading a tilt image relative to a piece of paper or a subject;

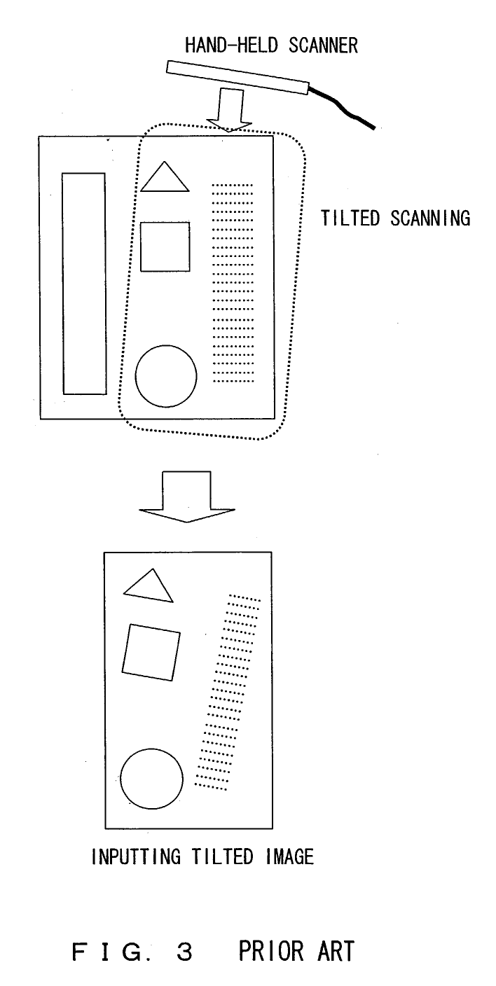

FIG. 4 shows the process of lowering the detection accuracy on the overlapping position without correcting the tilt of an image;

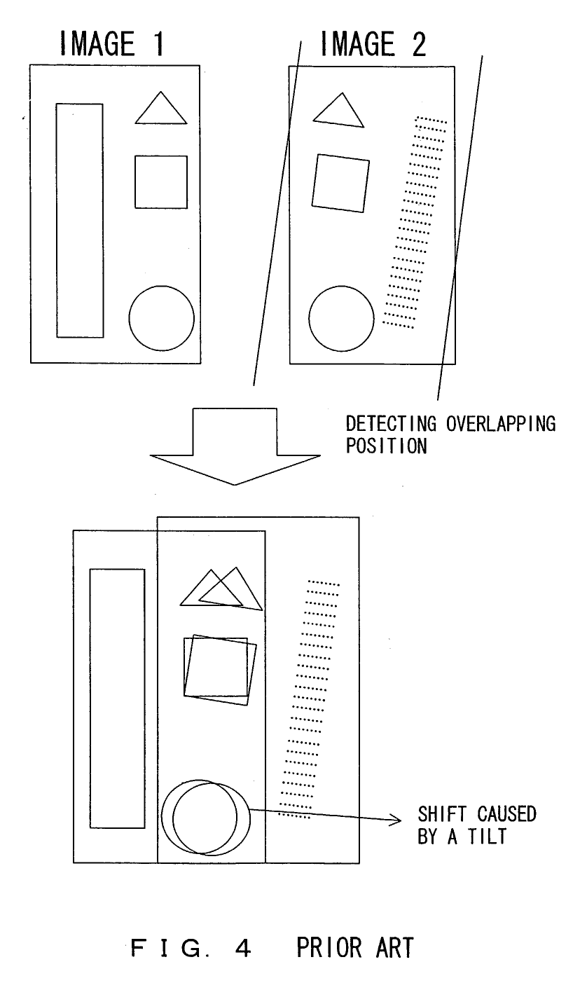

FIG. 5 is a block diagram of the functions of the image combining apparatus according to an embodiment of the present invention;

FIG. 6 shows the outline of the image combining method according to an embodiment of the present invention;

FIG. 7 is a flowchart of the process procedure of the image combining method according to the first embodiment of the present invention;

FIG. 8 shows the process of detecting a straight line portion to obtain a tilt angle; FIG. 8A shows detecting ruled lines; and FIG. 8B shows detecting boundary lines as straight portions;

FIG. 9 shows detecting a tilt angle based on a character string, and correcting the tilt angle;

FIG. 10 is a flowchart of the process procedure of the image combining method according to the second embodiment of the present invention;

FIG. 11 is a flowchart of the process procedure of the image combining method according to the third embodiment of the present invention;

FIG. 12 shows the combining method for combining three or more images obtained in three or more fetching operations;

FIG. 13 shows an example of the hardware configuration of an information processing device; and

FIG. 14 shows an example of a storage medium or a downloading process.

### DESCRIPTION OF THE PREFERRED EMBODIMENTS

The embodiments of the present invention are described below by referring to the attached drawings.

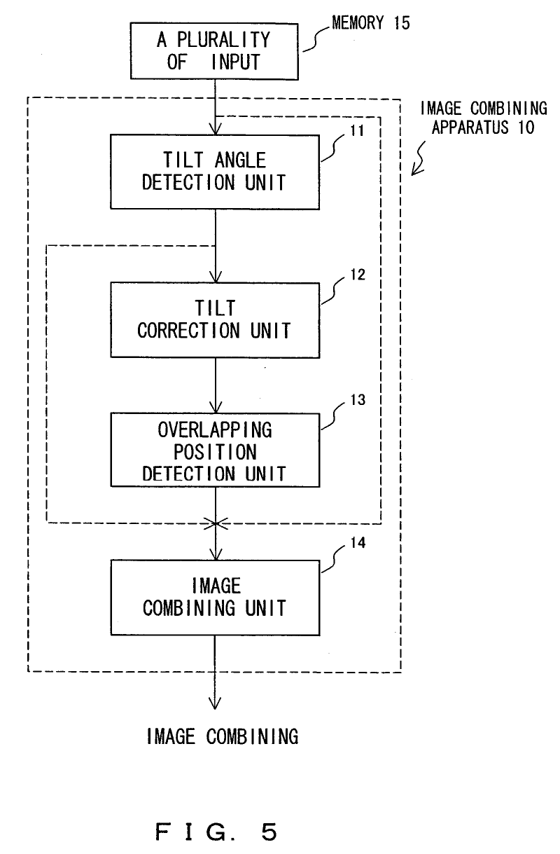

FIG. 5 is a block diagram of the functions of the image combining apparatus according to the present invention.

An image combining apparatus 10 according to the present invention comprises four central functional portions shown in FIG. 5, that is, a tilt angle detection unit 11, a tilt correction unit 12, an overlapping position detection unit 13, and an image combining unit 14.

First, assume that each of the images (hereinafter referred to as an input image) are obtained in two or more fetching operations using a scanner and a digital camera is stored in memory 15, etc.

The tilt angle detection unit 11 reads two input images in each input image from the memory 15, etc., and obtains the tilt angle relative to the piece of paper or subject of each input image. That is, for example, as described later, the tilt angle of the input image is obtained from the pattern information about color elements contained in each input image. As described later, an input image can be converted into a binary image, and the tilt angle can be obtained.

The tilt correction unit 12 corrects the tilt of each input image based on the tilt angle of each input image detected by the tilt angle detection unit 11.

The overlapping position detection unit 13 detects the overlapping position between the above mentioned two input images using the input image whose tilt is corrected by the tilt correction unit 12.

The image combining unit 14 combines the above mentioned two input images in the overlapping position detected by the overlapping position detection unit 13. When there are three or more input images, three or more input images can be grouped into one image by repeating the above mentioned processes.

Furthermore, the data used in the processes of the tilt correction unit 12 and the overlapping position detection unit 13 is not limited to input images, but can be the data obtained by reducing the amount of data of input images (for example, when input images are full-color images, they can be converted into gray-scale images), thereby performing the process at a higher speed. In this case, the image combining unit 14 reads again the input images stored in the memory 15, etc. as shown by the arrow in the figure, and the input images are combined using the tilt angle detected by the tilt angle detection unit 11 and the overlapping position detected by the overlapping position detection unit 13.

In the above mentioned processes, the processes by the overlapping position detection unit 13 and the image combining unit 14 can be performed by the technology disclosed in Japanese Patent Application No.11-111708, and the technology disclosed in Japanese Patent Application No.2001-107532 described by the applicant of the present invention. Furthermore, the image combining method of any other publication can be used. However, when the technology of Japanese Patent Application No.11-111708 or Japanese Patent Application No.2001-107532 is used, the effects of these inventions are added, thereby realizing a high-precision image combination and a high-speed process.

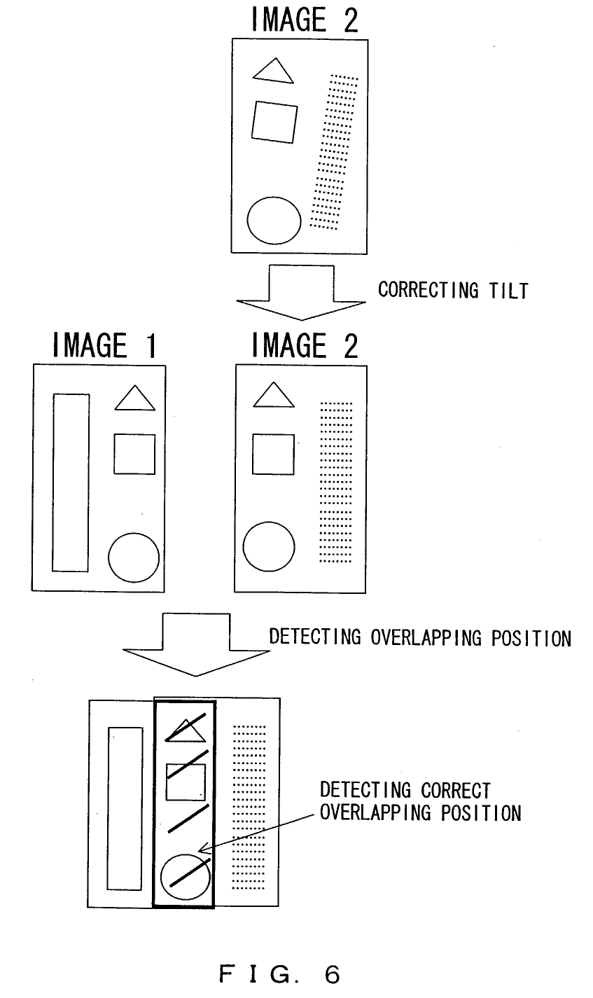

In the image combining method according to an embodiment of the present invention, for example, as shown by the outline in FIG. 6, a correct overlapping position can be detected and images can be combined in the processes of the overlapping position detection unit 13 and image combining unit 14 by automatically and rapidly correcting the tilts of the input images in the processes by the tilt angle detection unit 11 and the tilt correction unit 12 to be performed prior to the processes of the overlapping position detection unit 13 and the image combining unit 14. Therefore, the reduction in image quality by pixel shift can be avoided, and the image distortion can also be avoided, thereby accurately combining a plurality of input images.

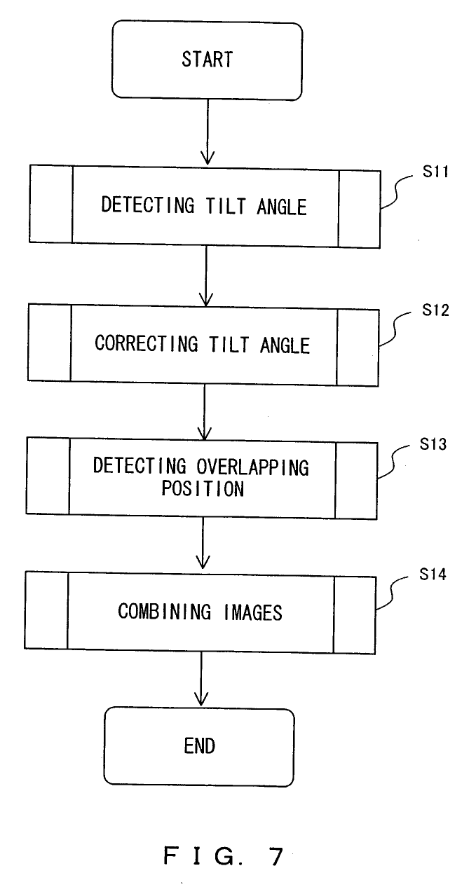

The first embodiment of the present invention is described below by referring to FIGS. 7 through 9.

FIG. 7 is a flowchart of the process procedure of the image combining method according to the first embodiment of the present invention.

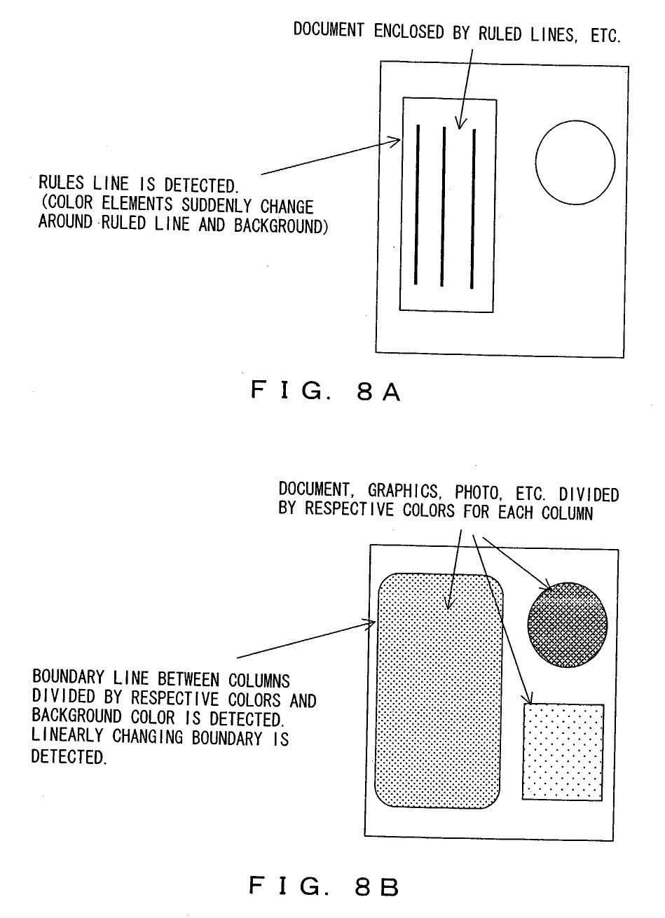

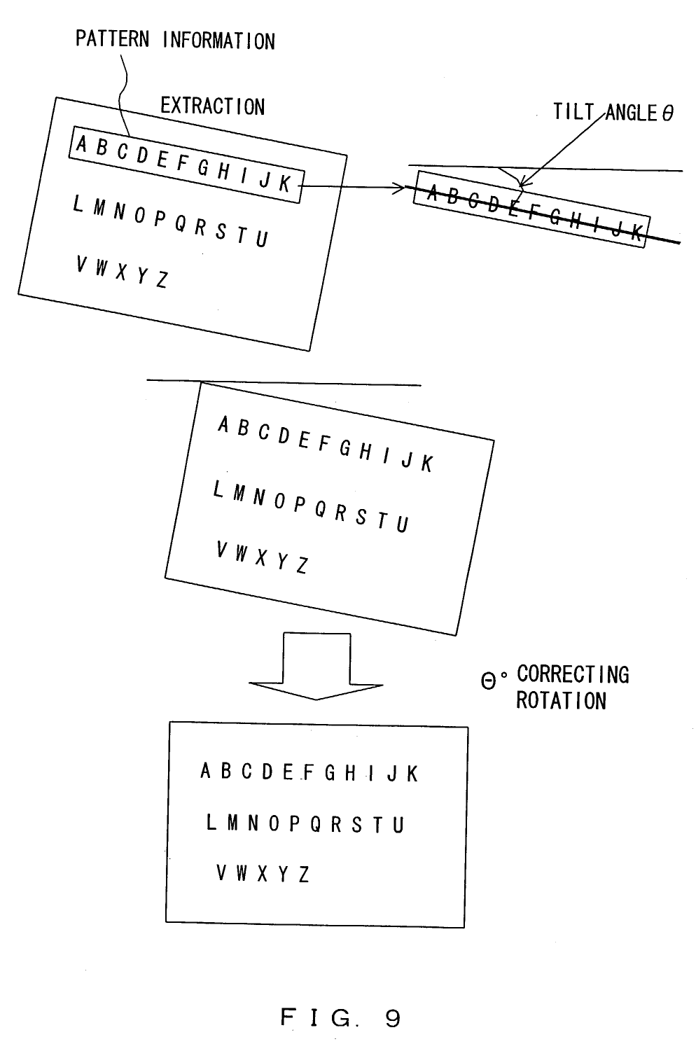

FIGS. 8A, 8B, and 9 show the outline of the process in step S11, that is, the process of detecting a tilt angle.

In FIG. 7, the tilt angle of the two input images to be combined is first detected (step S11).

In the process in step S11, for example, the tilt angle of an input image is obtained according to the pattern information about the color elements of the input image for each of the input images to be combined. Described below is the detailed explanation.

First, when the input image is a document image, there can be a ruled line in the input images as shown in FIG. 8A. In this case, the ruled line is detected, and the tilt angle of the ruled line is obtained, and then the tilt of the input image is obtained. Normally, a ruled line is drawn horizontally or vertically relative to the paper to be scanned. Therefore, ‘tilt of ruled line’ can be assumed to be ‘tilt of input image’.

A ruled line can be detected according to the pattern information about color elements. That is, the color elements are apparently different between a ruled line and a background, and the difference continues linearly. Therefore, a ruled line can be detected by detecting an area in which a portion having the ‘level of gradient’ higher than a predetermined value linearly continues.

Furthermore, for example, as shown in FIG. 8B, when each document is colored for each column, and when the boundary line between the ‘colored column’ and the ‘background color’ is detected, the tilt of the boundary line can be assumed to be the tilt of the input image. This can be applied to the data other than a document (photo, drawing, table, etc.) Furthermore, in the case of the data other than a document, a boundary line can be detected although data is not colored like the above mentioned columns. That is, when a part of read input images contains a photo, etc., a boundary line can be detected between the photo and the ‘background color’. However, in this case, it is assumed that the photo, etc. is in the shape including a linear element such as a rectangle, a square, etc.

The above mentioned ruled line and boundary area can be detected by detecting an area in which color elements indicate a sudden change, which can be obtained by a differential value of color elements.

The technology of differentiation can be either one-dimensional differentiation, two-dimensional differentiation, or any other well-known method. The color elements are differentiated to obtain the level of a gradient. The level higher than a predetermined value indicates an area of linear continuation. (For example, the technology described in ‘Process and Recognition of Image’ by Takeshi Agui/Tomoharu Nagao, published by Shokodo 19992.1.25, etc.)

In the above mentioned process, a linear portion can be detected.

Then, the relative tilt angle of the line to the input image is obtained. When the coordinates of the starting point of the detected line is set to (x1, y1), and the coordinates of the terminating point is set to (x2, y2), the level a of the tilt can be obtained by the following equation.

a=(y1−y2)(x1−x2)

Thus, the tilt angle θ is obtained from the following equation using arc-tangent.

θ=tan⁻¹ (a)

The obtained angle θ is defined as the tilt angle of an image.

Then, using the obtained tilt angle θ, the tilt angle of the image is corrected (step S12).

Then, the overlapping position of the image is detected (step S13). Then the overlapping position is detected, an image whose tilt has been corrected in step S12 is used. If the input image is a document image, the technology of Japanese Patent Application No.11-111708 is used. If the input image is an image other than a document image (photo, illustration, graphics, table, etc.), then the technology of Japanese Patent Application No.2001-107532, etc. is used. If the input image is a combination of a document image and an image other than a document image, then any of the above mentioned two technologies is used depending on whether a combined area contains a document image or an image other than a document image. The method of detecting an overlapping position can be any of the other well-known technologies.

Finally, the two images are combined (step S14). When images are combined, the images whose tilts have been corrected in step S12 are used. In combining images, as in step S13, the technologies of Japanese Patent Application No.11-111708 and Japanese Patent Application No.2001-107532 can be used. Other well-known technologies can also be used in combining images.

The process in step S11 can be performed on an input image which is a full-color image having the RGB color elements, or a gray-scale image having a single color element by converting the image into a binary image having two color elements, and detecting the tilt angle of the image using the binary image. The binarizing method can be, for example, the method disclosed by the Japanese Patent Application No.2000-31869 filed by the Applicant of the present invention. Any other methods can also be adopted.

Described below is the reason for conversion into a binary image.

First, an image having multivalued color elements such as a full-color image, etc. indicates a stepwise color change although its gray scale shows a sudden change. Especially, in a high resolution image, the gray-scale elements moderately change depending on the performance of an optical device of an input unit, for example, the resolution of a lens and the focus adjusting capability. For example, when a sheet of paper on which the color changes from white to black is input through an optical unit, the color does not suddenly change from 0 to 255 where 0 indicates black and 255 indicates white. That is, the color changes stepwise from 0 to 255 through 100, 200, etc. In this case, it is not easy to detect the boundary area between white and black.

On the other hand, according to the present embodiment, the boundary area can be easily detected by temporarily replacing a full-color image, etc. with a binary image. For example, when binarization threshold is assumed to be 128, 0 is set to 0, 100 is set to 0, 200 is set to 0, and 255 is set to 1. Therefore, it is easily understood that the boundary between 0 and 1 is the boundary line between white and black. The binarizing process allows the linear elements of an image to be easily and accurately detected. This also holds true with a gray-scale image having a single color element.

As described above, a number of images taken through a scanner and a digital camera are input as tilted relative to paper or a subject. Unless the tilt of each image is corrected, the detection accuracy at the overlapping position is lowered. Since the overlapping positions of the images do not completely match unless the tilt of each image is corrected, the image quality of the combined portion is lowered by the influence of a pixel shift. Furthermore, since the tilt angle changes at the boundary of the combined portion, the image is entirely distorted.

On the other hand, in the above mentioned image combining method according to the present embodiment, a tilt angle can be automatically and accurately obtained by obtaining the tilt angle of an image according to the pattern information about color elements, and the tilt angle of the image can be corrected based on the detected tilt angle (the image is corrected in the detected tilt direction. Thus, by combining the tilt corrected images, the deterioration of image quality and the distortion of an image can be avoided.

The detection of a tilt angle in step S11 is not limited to the above mentioned method. For example, when an input image is a document image or contains a document image (especially when no ruled lines are drawn), the method described in the Japanese Patent Application No.10-147822 as shown in FIG. 9 can be used.

In the invention described in the Japanese Patent Application No.10-147822, a character-like portion is extracted as a partial image from the extracted document image, a tilt angle is obtained from the extracted partial image, and a tilt angle of the input image is obtained based on the tilt angles. Thus, except when an input image is configured by only the images other than document images, the method described in the Japanese Patent Application No.10-147822 can be used.

Then, in step S12, as shown in FIG. 9, an input image is corrected by rotating it counterclockwise by the detected tilt angle θ.

Described below is the second embodiment of the present invention.

When an image to be processed is a full-color image, etc. having the RGB color elements, it takes a very long time to detect an overlapping position.

In the second embodiment, when an input image is a color image, it is first converted into a gray-scale image having a single color element to reduce the amount of data, and a process of detecting an overlapping position is performed, thereby reducing arithmetic operations and realizing a high-speed process.

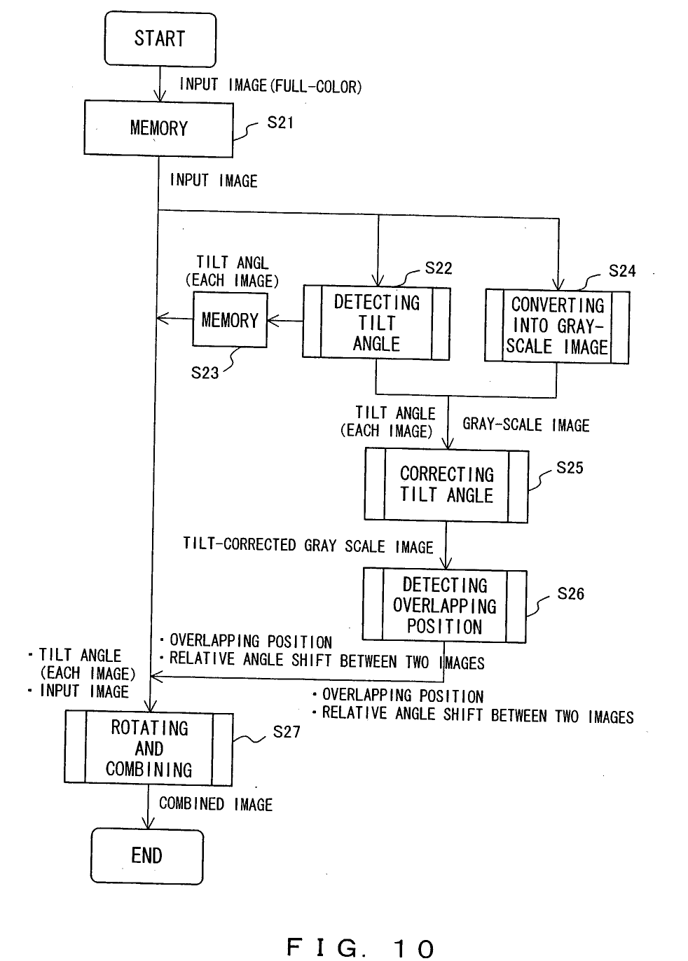

The procedure of the processes in the second embodiment is described below by referring to FIG. 10.

In this description, it is assumed that an input image is a full-color image having the RGB color elements, but the image can also be a full-color image having other color elements such as YCbCr, etc.

First, two input images (full-color images) are stored in the memory (step S21).

Then, each of the input images stored in the memory in step S21 is read, and the tilt angle is detected (step S22). The methods for detecting the tilt angle are described above in step S11. Especially, the method of converting into a binary image can easily and accurately detect a tilt angle, and can perform a high-speed process. Any other well-known methods other than the above mentioned methods can also be applied.

The tilt angle of each input image detected in step S22 is temporarily stored in the memory for use in combining input images in the subsequent step S27 (step S23). That is, in the present embodiment, the processes in steps S25 and S26 described later are performed at a high speed using gray-scale images, but the images are finally combined in the process in step S27 using input images (full-color images). Therefore, the tilt angle is temporarily stored in the memory as one of the parameters used therefor.

Next, an input image is converted into a gray-scale image having a single color element (step S24). For example, the input image is YCbCr-converted, and a gray-scale image is generated based on the Y element. The converting method is not limited to the above mentioned method. For example, the method of generating an image having a differential value as a pixel element using a differential filter, the method of converting one of the RGB color element for generating a gray-scale image, and other well-known converting methods can be used.

Then, using a gray-scale image obtained in the process in step S24, a tilt is corrected depending on each tilt angle detected in step S22 (step S25). The tilt correcting process can be the same as that referred to in step S12.

Using the gray-scale image tilt-corrected in step S25, the overlapping positions of two images and the relative angle shift are detected (step S26). The detecting method can be the methods described in the Japanese Patent Application Nos.11-111708 and 2001-107532, or any other well-known methods.

Finally, the input images (full-color images) stored in the memory are read again, and the input images are combined based on the tilt angles (of the respective input images) temporarily stored in step S23 and the overlapping positions and relative angle shift detected in step S26 (step S27). In this process, the images are rotated by the angle obtained by adding the ‘tilt angle’ to the ‘relative angle shift’, and are combined in the combined portions of the two images. The image combining method can be the same as that referred to in step S14.

As described above, according to the image combining method of the second embodiment, the tilt angle and the overlapping position (parameter) are detected based on the image (gray-scale image) whose amount of data has been reduced, and the input images are combined based on the above mentioned parameters finally using an input image (full-color image, etc.) whose amount of data is large, thereby quickly and accurately combining a plurality of images.

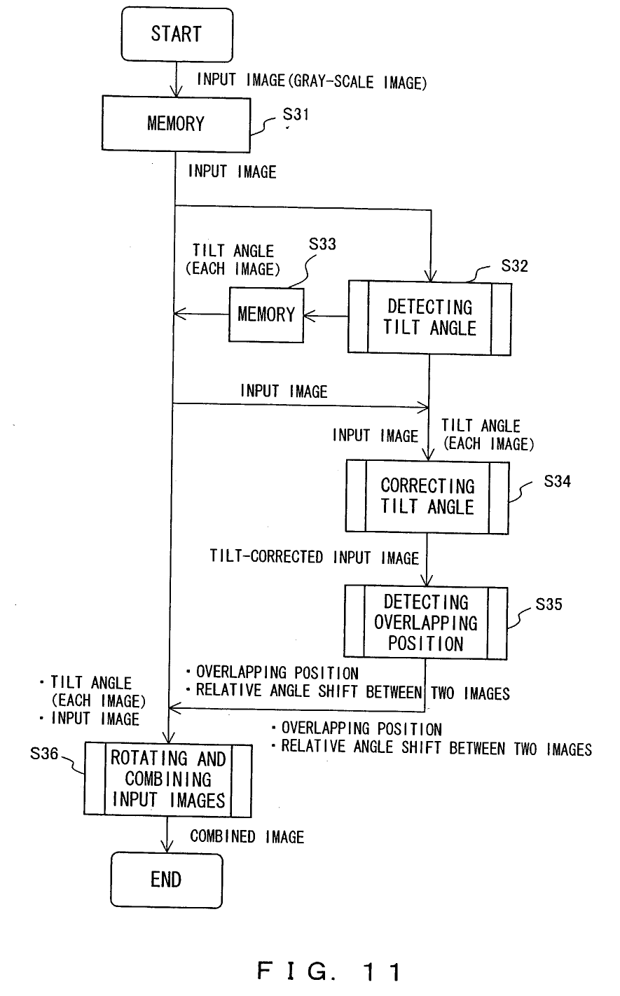

Relating to a high-speed process in the image combining method according to the present embodiment, a more effective process can be performed when the amount of data of an input image is large (in the case of a full-color image, etc.). The effect of easily and accurately combining images can also be obtained when an input image is, for example, a gray-scale image having a simple color element. The embodiment (third embodiment) of the present invention when an input image is a gray-scale image having a simple color element is described below by referring to FIG. 11.

FIG. 11 is a flowchart of the process procedure of the image combining method according to the third embodiment of the present invention.

In the present embodiment, an input image is, for example, a gray-scale image having a single color element.

First, two input images (gray-scale images) are stored in the memory (step S31).

Then, each of the input images stored in the memory in step S31 is read, and the tilt angle is detected (step S32). The methods for detecting the tilt angle are described above in step S11. Especially, the method of converting into a binary image can easily and accurately detect a tilt angle, and can perform a high-speed process. Any other well-known methods other than the above mentioned methods can also be applied.

The tilt angle of each input image detected in step S32 is temporarily stored in the memory for use in combining input images in the subsequent step S36 (step S33).

Next, the two input images (gray-scale images) stored in the memory are read again, and the tilt of each image is corrected (step S34). The tilt combining process can be the same as that referred to in step S12.

Using the gray-scale image tilt-corrected in step S34, the overlapping positions of two images and the relative angle shift are detected (step S35). The detecting method can be the methods described in the Japanese Patent Application Nos.11-111708 and 2001-107532, or any other well-known methods.

Finally, the input images (gray-scale images) stored in the memory are read again, and the input images are combined based on the tilt angles (of the respective input images) temporarily stored in step S33 and the overlapping positions and relative angle shift detected in step S35 (step S36). In this process, the images are rotated by the angle obtained by adding the ‘tilt angle’ to the ‘relative angle shift’, and are combined in the combined portions of the two images. The image combining method can be the same as that referred to in step S14.

As described above, according to the image combining method of the third embodiment, the tilt angle, the overlapping position, and the relative angle shift (parameters) are detected, and the input images are combined based on the parameters, thereby easily and accurately combining a plurality of images.

The combination of images according to the present embodiment is not limited to the image combination performed by reading two images obtained in two fetching operations for a object to be copied, scanned, or photoed, but three or more images obtained in three or more fetching operations can also be combined.

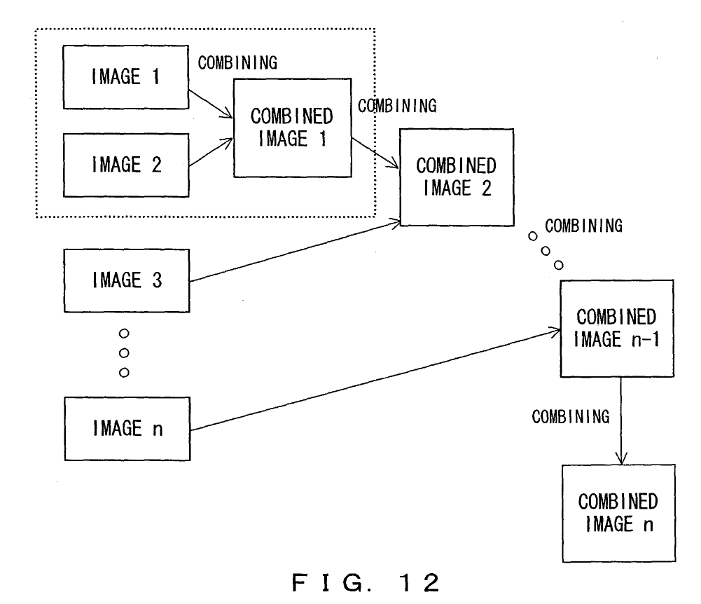

FIG. 12 shows the method of combining three or more read image sections obtained in three or more fetching operations.

As shown in FIG. 12, in the images obtained in three or more fetching operations, the above mentioned image combining process according to the present embodiment is first performed using the first read image 1 and the second read image 2, and the image 1 and the image 2 are combined into a combined image 1. Then, the combined image 1 is further combined with the third read image 3 into a combined image 2. Similarly, the read images are sequentially combined, thereby three or more images obtained in three or more fetching operations can be combined.

Finally described below are the inventions of the above mentioned Japanese Patent Application Nos. 2001-107532, 11-111708, and 2000-31869.

First, the invention of the Japanese Patent Application No.2001-107532 is described.

In the invention of the Japanese Patent Application No.2001-107532, the image combining process is performed in three stages. This method is especially effective when the amount of data of an input image is large (color image, etc.).

In the first stage, a ‘rough overlapping position detecting process’ is performed. For example, the combination position relationship (the above mentioned rotation angle and/or absence/presence of a mirror image) between the two images is detected using the image data (for example, a reduced image of a single gray-scale image) whose data amount is considerably reduced and whose data has been input through input equipment such as a hand-held scanner, etc. Additionally, the ‘rough overlapping area’ between the two images in the detected combination position relationship is detected.

Next, in the second stage, the ‘correct overlapping position detecting’ process is performed on the two images.

In this process, when a scanned image is a full-color image, image data obtained by converting the scanned image into a single gray-scale image is used. Then, based on the ‘rough overlapping area’ detected in the first stage, an area used as a joint surface (used in the combining process) between the correct overlapping positions of the two images. In this process, a ‘rough overlapping area’ is divided into a plurality of rectangular areas, an area used in detecting a correct overlapping position is determined from among rectangular areas containing a large number of density elements indicating large color differences, and a rectangular area used as a joint surface between the two images is determined from among the rectangular areas containing a large number of density elements indicating small color differences.

Furthermore, using the rectangular areas divided as described above, the relative tilt of the second scanned image (hereinafter referred to as a first image) to the first scanned image (hereinafter referred to as a first image) is detected.

Then, in the third stage, the process of combining the two scanned image is performed. As a results of the processes performed in the above mentioned first and second stages, the combination position relationship (rotation angle, and/or presence/absence of mirroring) between the two images, the relative tilt, the correct overlapping positions, and the rectangular areas used as joint surfaces are obtained. Therefore, the two images can be combined.

Next, the invention described in the Japanese Patent Application No.11-111708 is described below.

In the invention described in the Japanese Patent Application No.11-111708, for example, a character area is extracted from each of a plurality of document images, a character is recognized in the character image in the extracted character area, the overlap among a plurality of document images is detected based on the character recognition result, and a plurality of document images are combined in the detected overlapping position.

Otherwise, for example, a character area is extracted from each of the divided and read document images and compared in size with the positions of the plurality of character areas of the plural of the extracted document images, a plurality of character areas indicating higher matching levels are detected, an overlap among a plurality of document images is detected based on the positions of the plurality of the detected character areas indicating higher matching levels, and the plurality of document images are combined in the detected overlapping position.

Described below is the invention described in the Japanese Patent Application No.2000-31869.

In the invention described in the Japanese Patent Application No.2000-31869, the histogram of density values of the read image data of each color element is generated, the peak value on the high density side and the peak value on the low density side are obtained from the histogram, and the comparison result between them is determined for each color element. For example, if there are a larger number of color elements having a peak value on the high density side larger than the peak value on the low density side, then the binarizing process is performed on the color elements.

For example, if the read image data is the image data of the three color elements of RGB, then the level of the above mentioned peak values is determined for each of the R, G, and B. Then, for example, if the color elements having a larger peak value on the high density side than the peak value on the low density side are R and G, and the color element having a smaller peak value on the high density side than the peak value on the low density side is B, then the binarizing process is performed on the R and G elements.

Then, for example, each pixel of the R/G elements is compared with a threshold. If at least one of the elements exceeds the threshold, then the pixel is white. If none of them exceed the threshold, then the pixel is black. Thus, the binarizing process is performed.

Although there are a larger number of color elements having a peak value on the low density side larger than the peak value on the high density side, the binarizing process can be performed on the larger number of color elements. However, in this case, a white pixel and a black pixel are inverted after the binarizing process.

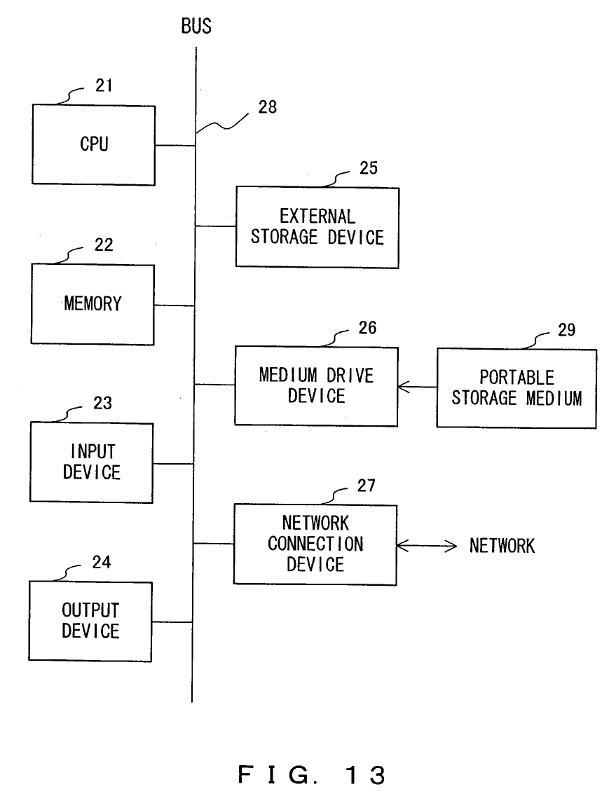

FIG. 13 shows an example of a hardware configuration of the information processing device realizing the above mentioned image combining apparatus according to the present embodiment. The information processing device (computer) is, for example, a personal computer, etc., but is not limited thereto. For example, a flat bed scanner, a hand-held scanner, or a device built in a digital camera (that is, built-in equipment, etc.). Otherwise, it can be any device having an information processing ability.

An information processing device (computer) 20 shown in FIG. 13 comprises a CPU 21, memory 22, an input device 23, an output device 24, an external storage device 25, a medium drive device 26, a network connection device 27, etc., and they are interconnected through a bus 28. The configuration shown in FIG. 13 is an example, and is not the device is not limited to the example.

The CPU 21 is a central processing unit for entirely controlling the information processing device 20.

The memory 22 can be, for example, RAM, etc. temporarily storing a program or data stored in the external storage device 25 (or a portable storage medium 29) when the program is executed, data is updated, etc. The CPU 21 executes the above mentioned various processes using the program/data read to the memory 22.

The input device 23 is, for example, a keyboard, a mouse, a touch panel, etc.

The output device 24 is, for example, a display, a printer, etc.

The external storage device 25 is, for example, a hard disk device, etc., and stores a program/data (program for executing the processes shown in FIGS. 7, 10, 11, etc.) for realizing each function of the image combining apparatus according to the above mentioned embodiments of the present invention.

The medium drive device 26 reads the program/data stored in the portable storage medium 29 (or writes). The portable storage medium 29 is, for example, an FD (flexible disk), CD-ROM, DVD, a magneto-optical disk, etc.

The network connection device 27 is connected to a network (Internet, etc.) for allowing the apparatus to transmit/receive program/data, etc. with an external information processing device.

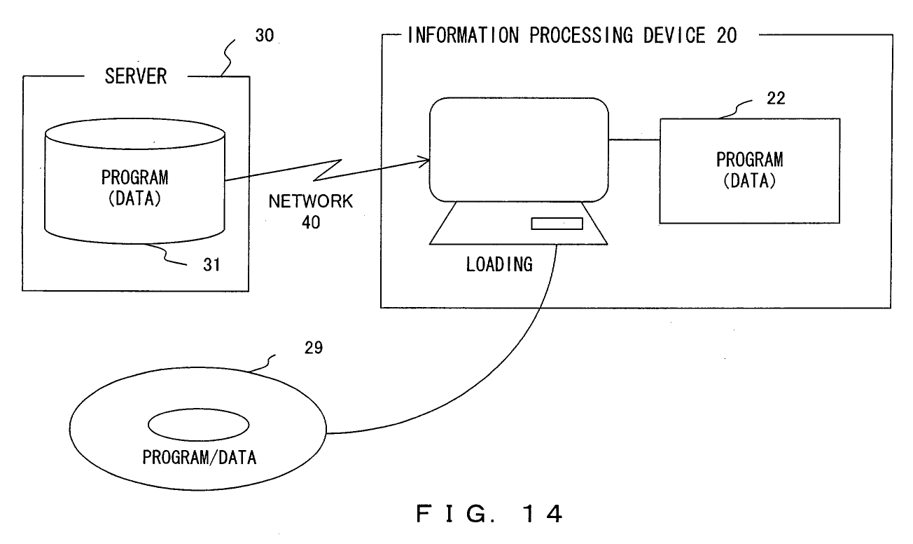

FIG. 14 shows an example of a storage medium.

As shown in FIG. 14, the portable storage medium 29 storing a program/data for realizing the function of the present invention is inserted into the body of the information processing device 20, etc. to read the program/data to the memory 22 which stores them for later use, and the program/data can be obtained by downloading a program/data 31 stored in a server 30 of an external program/data server through a network 40 (Internet, etc.) connected by the network connection device 27.

Furthermore, the present invention is not limited to an apparatus/method, but can be configured as a storage medium (portable storage medium 29, etc.), and can be configured as a program.

As described above in detail, according to the image combining apparatus, the image combining method, etc. of the present invention, a user can obtain convenient means, a plurality of input image can be accurately combined, and a high-speed process can be performed although an input image has a large amount of data by automatically correcting the tilt of each input image and combining input images in the method of combining the input images obtained by reading a target image in a plurality of reading processes.

The present invention largely depends on the operability of inputting an image using a hand-held scanner, etc. and the improvement of a user interface.

What is claimed is:

1. An image combining apparatus, comprising:
a tilt angle detection unit obtaining a tilt angle of each input image for a plurality of input images obtained in two or more fetching operations;
a tilt angle correction unit correcting the tilt angle of each input image based on the tilt angle detected by said tilt angle detection unit;
an overlapping position detection unit detecting an overlapping position between input images using the input images whose tilt angles are corrected by said tilt angle correction unit; and
an image combining unit combining the plurality of input images based on the overlapping position detected by said overlapping position detection unit.

2. The apparatus according to claim 1, wherein
said tilt angle detection unit converts the input image into a binary image having two color elements, and detects the tilt angle using the binary image.

3. The apparatus according to claim 2, wherein
said tilt angle detection unit extracts a character string portion as a partial image and obtains the tilt angle from the extracted partial image, or extracts a ruled line or a boundary line according to pattern information about a color element in the input image, and obtains the tilt angle based on a tilt of the ruled line or the boundary line.

4. The apparatus according to claim 1, wherein
said overlapping position detection unit converts the input image into a gray-scale image having a single color element or a binary image having two color elements, and detects the overlapping position using the gray-scale image or the binary image.

5. The apparatus according to claim 1, wherein:
said overlapping position detection unit generates a reduced image obtained by reducing an amount of data of the input image, and detects a combination position relationship among the plurality of input images and a rough overlapping area using the generated reduced image; and
said image combining unit combines the plurality of input images based on the detected combination position relationship and rough overlapping area.

6. The apparatus according to claim 1, wherein:
said overlapping position detection unit detects a rough overlapping area among the input images, divides the detected rough overlapping area into a plurality of rectangular areas, and extracts a rectangular area for use in detecting a correct overlapping position and a rectangular area for use as a joint surface from among the rectangular areas obtained by dividing the detected rough overlapping area; and
said image combining unit determines a correct overlapping position among the input images using the rectangular area for use in detecting the correct overlapping position, and combines the input images in the rectangular area for use as the joint surface.

7. The apparatus according to claim 5, wherein
said combination position relationship refers to presence/absence and/or a rotation angle of another input image in the input images.

8. The apparatus according to claim 6, wherein
said combination position relationship refers to presence/absence and/or a rotation angle of another input image in the input images.

9. The apparatus according to claim 5, wherein:
said rectangular area for use in detecting the correct overlapping position is a rectangular area selected from among rectangular areas including a large number of density elements indicating large color differences; and
said rectangular area for use as a joint surface of the image is a rectangular area selected from among rectangular areas including a large number of density elements indicating small color differences.

10. The apparatus according to claim 6, wherein:
said rectangular area for use in detecting the correct overlapping position is a rectangular area selected from among rectangular areas including a large number of density elements indicating large color differences; and
said rectangular area for use as a joint surface of the image is a rectangular area selected from among rectangular areas including a large number of density elements indicating small color differences.

11. An image combining method, comprising:
obtaining a tilt angle of each input image for a plurality of input images obtained in two or more fetching operations;
correcting the tilt angle of each input image based on the obtained tilt angle;
detecting an overlapping position between input images using the input images whose tilt angles are corrected; and
combining the plurality of input images based on the detected overlapping position.

12. An image combining method, comprising:
obtaining a tilt angle of each input image for a plurality of input images obtained in two or more fetching operations by converting each of the input images into a binary image having two color elements, and extracting a straight line contained in each input image using the binary image;
correcting the tilt angle of each input image based on the obtained tilt angle;
detecting an overlapping position between input images using the input images whose tilt angles are corrected; and
combining the plurality of input images based on the detected overlapping position.

13. An image combining method, comprising:
obtaining a tilt angle of each input image for a plurality of input images obtained in two or more fetching operations;
converting the input image into a gray-scale image having a single color element or a binary image having two color elements;
correcting the tilt angle of the gray-scale image or binary image based on each tilt angle;
detecting an overlapping position between input images using the gray-scale image or binary image whose tilt angles are corrected; and
combining the plurality of input images based on the detected overlapping position.

14. A computer-readable storage medium storing a program used to direct a computer to realize the functions of:
obtaining a tilt angle of each input image for a plurality of input images obtained in two or more fetching operations;
correcting the tilt angle of each input image based on the obtained tilt angle;
detecting an overlapping position between input images using the input images whose tilt angles are corrected; and
combining the plurality of input images based on the detected overlapping position.

15. A computer-readable storage medium storing a program used to direct a computer to realize the functions of:
obtaining a tilt angle of each input image for a plurality of input images obtained in two or more fetching operations by converting each of the input images into a binary image having two color elements, and extracting a straight line contained in each input image using the binary image;
correcting the tilt angle of each input image based on the obtained tilt angle;
detecting an overlapping position between input images using the input images whose tilt angles are corrected; and
combining the plurality of input images based on the detected overlapping position.

16. A computer-readable storage medium storing a program used to direct a computer to realize the functions of:
obtaining a tilt angle of each input image for a plurality of input images obtained in two or more fetching operations;
converting the input image into a gray-scale image having a single color element or a binary image having two color elements;
correcting the tilt angle of the gray-scale image or binary image based on each tilt angle;
detecting an overlapping position between input images using the gray-scale image or binary image whose tilt angles are corrected; and
combining the plurality of input images based on the detected overlapping position.

17. A computer program embodied on a transmission medium used to direct a computer to realize the functions of:
obtaining a tilt angle of each input image for a plurality of input images obtained in two or more fetching operations;
correcting the tilt angle of each input image based on the obtained tilt angle;
detecting an overlapping position between input images using the input images whose tilt angles are corrected; and
combining the plurality of input images based on the detected overlapping position.
